(19) United States
(12) Patent Application Publication
(10) Pub. No.: US 2013/0161223 A1
(43) Pub. Date: Jun. 27, 2013

(54) Drain Cup

(71) Applicant: Michael Tessier, Warwick, RI (US)

(72) Inventor: Michael Tessier, Warwick, RI (US)

(21) Appl. No.: 13/336,029

(22) Filed: Dec. 23, 2011

(51) Int. Cl. B65D 85/00; B23P 19/00

(52) U.S. Cl. 206/525; 29/426.1

(57) ABSTRACT

A drain cup device is provided to limit oil spills when removing an oil filter from a vehicle. The device has a body which forms a container for receiving the oil filter. The container further has a volume sufficient to contain the oil filter as well as a quantity of spilled oil. In one embodiment, the present invention may be provided as packaging for a new oil filter.

### BACKGROUND OF THE INVENTION

1. Field of the Invention

The present invention relates generally to the replacement of oil filters in motorized vehicles. More particularly, the present invention relates to an oil filter packaging that may contain a new or spent oil filter, as well as a quantity of motor oil.

2. Description of Related Art

Oil changes are a vital part of engine maintenance. Indeed, every vehicle requires multiple oil changes throughout its life. One substantial aspect of an oil change is replacement of an oil filter.

The process of changing an oil filter is often a messy experience with a high likelihood of oil spillage. Much of this oil spills from a portion of the engine referred to as a gallery, where a quantity of oil pools near the oil filter, and spills out from around the filter when the oil filter is being removed.

Mechanics and those who perform oil changes on their own have created a number of crude solutions to the problem of oil spillage while removing the oil filter. Some of these solutions include stuffing a rag or plastic material around the filter during removal, puncturing a filter and casing to drain excess oil, or using a basin to catch spilled oil. However, most of these methods still involve a good deal of spillage, and/or are difficult to implement successfully.

Therefore, what is needed is a device that may act as a tool to catch spilling oil, aid in removal of the filter, and safely store the spilled oil and spent oil filter.

### SUMMARY OF THE INVENTION

The subject matter of this application may involve, in some cases, interrelated products, alternative solutions to a particular problem, and/or a plurality of different uses of a single system or article.

In one aspect, an oil filter drain cup is provided. The drain cup comprising a body which forms a container constructed and arranged to receive and contain the oil filter and a quantity of oil. The drain cup further comprises a cover attachable to the body. The cover allowing fluid flow in and out of the container in an open position, and obstructing fluid flow in a closed position. The drain cup further comprises a portion sized to engage with at least a part of an outer surface of the oil filter. The present invention may be utilized in oil filter replacement for any motorized device, including but not limited to automobiles, marine vehicles, and aviation vehicles.

In another aspect, a method of preventing oil spillage when removing a vehicle oil filter is provided. The method comprises the steps of loosening the oil filter partially, placing a drain cup over the oil filter by inserting the oil filter into a container formed by a body of the drain cup, loosening the oil filter completely, receiving the drained oil into the oil filter drain cup, and securing a cover to the oil filter drain cup.

### BRIEF DESCRIPTION OF THE DRAWINGS

FIG. 1 provides a perspective view of an embodiment of the drain cup.

FIG. 2 provides a perspective view of another embodiment of the drain cup.

FIG. 3 provides a top view of an embodiment of the drain cup.

FIG. 4 provides a bottom view of an embodiment of the drain cup.

FIG. 5 provides a side view of an embodiment of the drain cup.

FIG. 6 provides a perspective view of an embodiment of the drain cup being sealed with a cover.

FIG. 7 provides a perspective view of an embodiment of an adapter for the drain cup.

FIG. 8 provides a perspective view of another embodiment of the drain cup.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a drain cup device constructed and arranged to store an oil filter, as well as a quantity of oil that may leak from a vehicle. The present invention comprises a body, which forms a container for storing the oil filter and oil. The present invention may further comprise a cover, which allows communication between the container and an outer atmosphere in an open position, and forms a substantially fluid-tight seal of the container when in a closed position. The cover may further allow the container to be re-sealable.

The drain cup device may be provided to consumers in any number of manners. In one embodiment, the device may be provided as a packaging of a new oil filter. In a further embodiment, the package may be used to store and receive a spent oil filter that a new filter is intended to replace. Alternatively, in another embodiment, the container may be saved and used when removing the oil filter that was originally packaged in it, once the filter has been used. In another embodiment, reusable devices may be sold individually or in a group, with or without oil filters.

In another embodiment, the drain cup device may be provided as a separate product. In this embodiment, the drain cup device may be re-useable to remove and/or drain a plurality of different oil filters.

The body may be constructed of any substantially motor oil-impermeable material. Preferably, the body is constructed of a material sufficiently rigid and durable to securely store an oil filter and a quantity of oil. Materials of which the body may be constructed of include, but are not limited to plastics, multiple different plastics, composite materials, metal, wood, reinforced paper, and the like.

In one embodiment, the body may be constructed of a molded plastic. In a further embodiment, the body may be constructed using dual plastic injection molding (also referred to as “two shot molding”), wherein a first plastic is used to form a top portion of the body, and wherein a second plastic is used to form a bottom portion of the body. In another embodiment, the body may be vacuum formed plastic. An embodiment of the vacuum formed body may have an oil filter with a gasket end abutting a cardboard insert; the body may then be formed around either the oil filter, or a mold surrounding the oil filter.

In yet another embodiment, the body may have a substantially circular cross section and may form a substantially cylindrical outer surface. The container formed by the body may also have a substantially circular cross section and may define a cylindrical opening in which an oil filter and/or oil may be received.

In still a further embodiment, the body may be constructed to have varying rigidity, with a flexible region at a top of the body, and a more rigid region at a bottom of the body. In this embodiment, the body may be constructed of different materials, or one material of varying thickness. This flexibility of this embodiment may allow the body to be easily inserted into a relatively small space around an oil filter by flexing it into position.

The container formed by the body may be designed and sized to contain not only an oil filter, but a quantity of oil as well. In this manner, the container may serve as a spill-prevention device to catch oil that spills from a gallery of a vehicle. In one embodiment, the body may be sized to accept a particular model oil filter. In this embodiment, the container may be specifically sized to contain a volume of oil typically found in a gallery of the vehicle or vehicles that the particular oil filter is to be used with.

The body may be configured to have a height greater than that of an oil filter. In one embodiment, the body may be formed to extend past a protruding oil filter mounted to a vehicle. In this embodiment, the oil filter may be inserted into the container of the body, the body extending past the oil filter to catch any leaking fluids from around the filter as it is removed.

In a further embodiment, the diameter of the container formed by the body may increase, extending outwardly at its top, thereby forming a lip with a greater diameter than the remainder of the body.

In one embodiment, the container formed by the body is constructed and arranged to provide a slight interference between the outer surface of the oil filter and a surface of the body. In this embodiment, friction between the oil filter and a surface of the body allows the oil filter to be securely held in the container. In a further embodiment, the friction between the oil filter and the surface of the body may be sufficient that a force additional to gravity must be applied when removing the filter from the container.

One or a plurality of ribs may extend from an inner surface of the body. The rib may be configured horizontally or vertically. In one embodiment, the rib or ribs may provide a slight interference between the outer surface of the oil filter and a surface of the rib causing friction between the two. In this embodiment, the rib may allow the container to securely hold the filter while simultaneously allowing a sufficient interior volume of the container to store spilled oil.

In embodiments where the ribs are vertically oriented along the length of the container, the rib length and may vary. For example in one embodiment the ribs may extend from a bottom of the container almost to the top. In another embodiment, the ribs may extend from the bottom of the container, to approximately ⅓ of the way up the container. Moreover, in these embodiments, a leading face of the ribs facing the top may vary in configuration. In one embodiment, the leading face of the ribs may be perpendicular to an inner surface of the container. In another embodiment, the leading face of the ribs may be angled downward, forming an acute angle between it and the inner surface of the container.

A bottom portion of the container formed by the body may be formed as a slot. In one embodiment, the slot may be constructed to engage a plurality of wrenching facets (faces configured to be engaged by a wrench) stamped onto an outer surface of the oil filter. In a further embodiment, the slot may form a substantially hexagonal cross section. In this embodiment, the slot may prevent rotational movement of the filter when it is seated in the slot of the body. In most embodiments, the slot may be at a bottom part of the body only. In one embodiment, the slot may be formed as part of the ribs. In another embodiment, the slot may be formed separately from the ribs. In still another embodiment, the slot may be present without the ribs.

A ridge or ridges may be formed on an outer surface of the body. In one embodiment, the ridges may be on a bottom outer portion of the body. The ridge or ridges may aid in manual manipulation of the body, allowing it to be rotated and held easily.

The re-sealable container may further comprise a cover that serves to seal the container formed by the body. This cover may obstruct fluid flow through an outlet of the container when the cover is in a closed position, and may allow fluid flow to and from the container when in an open position. The cover may be of any size and shape capable of obstructing fluid flow through the container. In a further embodiment, the cover may comprise a hinge or other device that is constructed and arranged to allow the cover to move between an open position and a closed position. In some embodiments, the cover may create a substantially air tight seal and/or a substantially oil tight seal on an inner or outer surface of the body.

The cover may connect to the body by any suitable connecting structure allowing movement between an open position and a closed position. For example, the cover may slide between positions. Additional examples may include the cover connecting by a multi-part hinge, a living hinge, a ball and socket hinge, butterfly hinge, lanyard, screw top, or pressure fit. The cover may be permanently attached to the body, or may be fully removable.

The cover may be constructed of any material capable of obstructing fluid flow to and from the container; preferably the fluid flow is an oil flow. Materials of which the cover may be constructed include, but are not limited to plastics, metals, wood, composite material, reinforced cardboard, and the like. The cover may be manufactured using methods such as injection molding, blow molding, vacuum forming, and the like. Further, the cover may be constructed as integral with the body, or separate from the body.

The cover may be designed to remain in a closed position. By remaining in a closed position, the cover can maintain its fluid obstruction to the container. In one embodiment, the cover may be held in a closed position by a pressure fitting. In still another embodiment, the cover may be held in a closed position by a screw fitting. In another embodiment, the cover may be held in a closed position by a snap fitting. In yet another embodiment, the cover may have a latch that is designed to hold the cover in a closed position.

A gasket may be provided on either the cover or the outer surface of the body. The gasket may aid in sealing the cover to the body. The gasket may be constructed of any material that may aid in sealing the cover-body interface. In one embodiment, the gasket may be an oil-resistant plastic.

The drain cup may further comprise a flanged adapter attached to a top of the body. The adapter may be made of materials similar to the cover, and in similar manners. The flanged adapter may be a removable ring shaped device capable of attachment to the top of the body.

In one embodiment, the flanged adapter may attach to an outside of the body, and have a flanged portion that extends inwardly, narrowing the diameter of the outlet of the container. In another embodiment, the flanged adapter may attach to an inside of the body. In one embodiment, the flanged portion of the adapter may form an aperture just wide enough for an oil filter to pass through it. In a further embodiment, the adapter may be configured to allow the cover to attach to the body over the adapter. In a preferred embodiment, the adapter may form a substantially oil tight seal around an interface between the adapter and the body.

One embodiment of use of the present invention may involve using the container both as a vessel for the oil filter and oil, as well as a tool for removal of the oil filter. In this embodiment, a wrench or other tool may be used initially to slightly loosen the oil filter. Once loosened, the drain cup device may then be placed about the filter. The filter may be further loosened, likely by either friction between the container and the oil filter, or engagement of slot features of the body with wrenching facets stamped onto the filter. A user may then manually rotate the container body which in turn will rotate the oil filter, unscrewing the filter and allowing it to be removed. During this removal process, oil may spill out around the oil filter and may be captured by the container which extends around and beyond the filter. Once the filter is fully unscrewed or otherwise removed, the container may be brought away from the vehicle after having caught substantially all draining oil. A cover may be attached to the body, sealing the container after removal. The sealed container and/or the contents therein may then be properly disposed of without leaking.

In a further embodiment, the frictional force between the oil filter and the container may allow the device to be left in position without monitoring by a user. In this embodiment, time for drainage is possible without a user needing to hold the cup in place. Further, in this embodiment, the container may be constructed and arranged to provide friction sufficient to not only hold the container to the oil filter against gravity, but also to hold the additional mass of the drained oil that drains into the container.

In vehicles having horizontally oriented oil filters, the present invention may be utilized. For these vehicles, the adapter noted above may be attached to a top of the body of the drain cup. The adapter may form a reservoir bounded by a bottom of the body, a side of the body, and the height of a flange of the adapter. A user may then place the drain cup over the oil filter and receive the oil filter into ribs and/or a slot of the body, thereby limiting rotational motion of the oil filter with respect to the body. The drain cup body may then be rotated, allowing removal of the oil filter. The reservoir formed in part by the adapter may serve to catch any oil spilling from around the oil filter upon removal. Upon complete removal of the oil filter, and reception of any spilled oil, the body and oil filter therein may be removed, sealed, and properly disposed of.

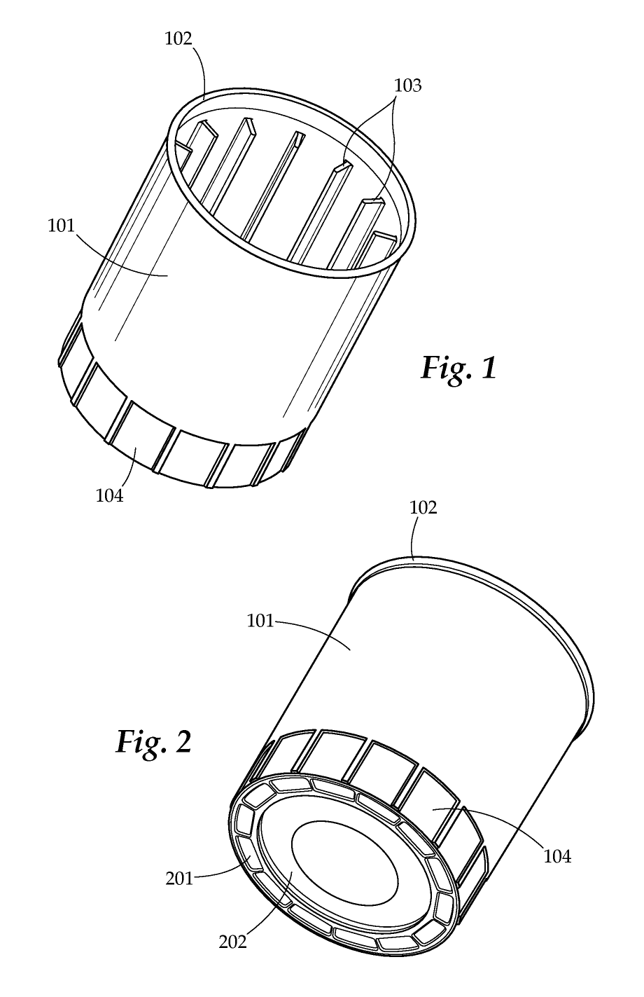

Turning now to FIG. 1, a perspective view of an embodiment of the drain cup is provided. The drain cup has a body 101 which provides structure for the device. An upper lip 102 is formed by the body. The upper lip 102 may extend slightly from the remainder of the body 101. A plurality of ribs 103 are formed vertically on an inner surface of the body 101. The ribs 103 are configured to receive an oil filter (not shown). Ridges 104 are formed on an outer surface of the body 104. The ridges 104 may facilitate manipulation and handling of the body 101.

FIG. 2 shows a perspective view of another embodiment of the drain cup. The drain cup has a body 101 which provides structure for the device. An upper lip 102 is formed by the body. The upper lip 102 may extend slightly from the remainder of the body 101. Ridges 104 are formed on an outer surface of the body 104. The ridges 104 may facilitate manipulation and handling of the body 101. Depressions on the lower surface 202 of the body 101 form slots 201 to engage wrenching facets formed on an oil filter (not shown).

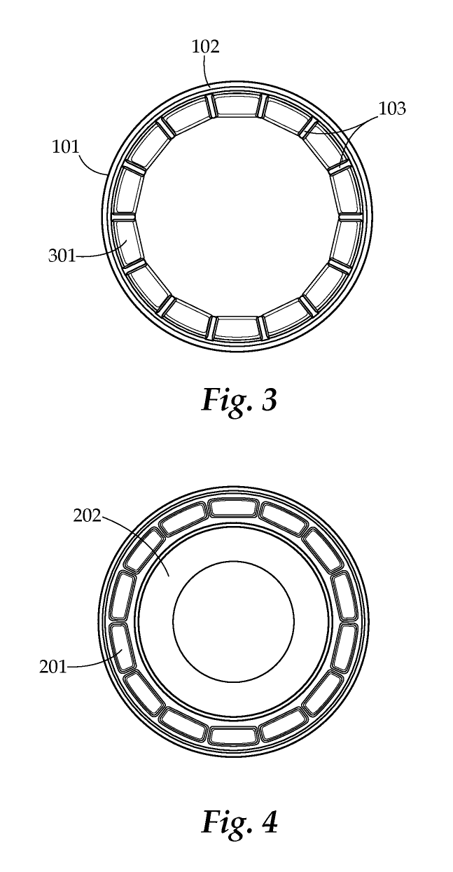

FIG. 3 provides a top view of an embodiment of the drain cup. The body 101 forms the structure of the device. An upper lip 102 can be seen extending slightly to aid in catching spilling oil. A plurality of ridges 103 are formed vertically on an inner surface of the body 101. A plurality of slots 301 are formed on a lower surface of the body 101. The slots 301 may engage wrenching facets on an oil filter.

FIG. 4 provides a bottom view of an embodiment of the drain cup. In this view, depressions can be seen on the lower surface 202 of the body 101 that form slots 201 to engage wrenching facets formed on an oil filter (not shown).

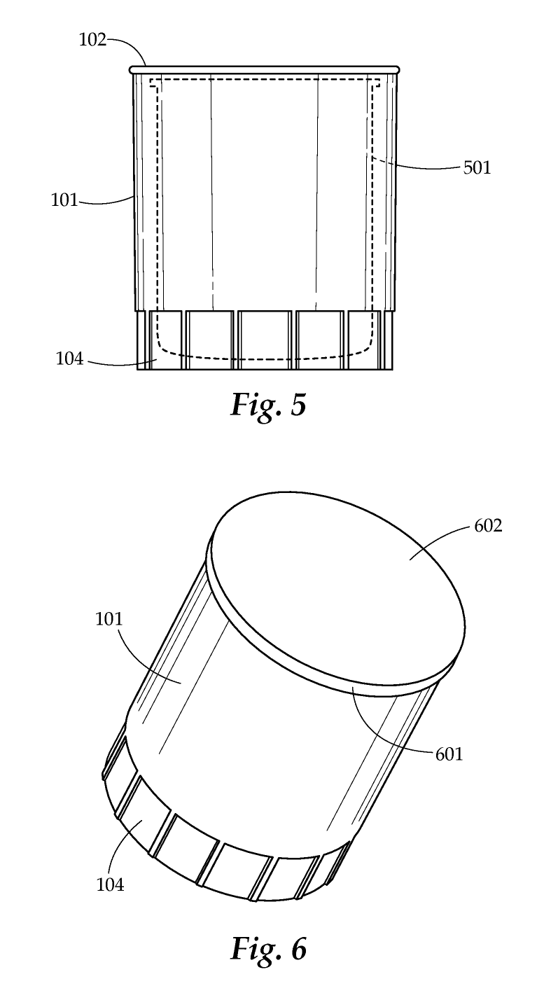

FIG. 5 provides a side view of an embodiment of the drain cup. The drain cup has a body 101 which provides structure for the device. An upper lip 102 is formed by the body. The upper lip 102 may extend slightly from the remainder of the body 101. Ridges 104 are formed on an outer surface of the body 104. The ridges 104 may facilitate manipulation and handling of the body 101. A profile of an oil filter 501 is shown inserted within the cup.

FIG. 6 provides a perspective view of an embodiment of the drain cup being sealed with a cover. The drain cup has a body 101 which provides structure for the device. Ridges 104 are formed on an outer surface of the body 104. The ridges 104 may facilitate manipulation and handling of the body 101. A cover 601 is attached to the body 101 in a closed position. The cover is attached around a flange 602 extending from the cover 601. In this embodiment, the flange 601 snaps over the upper lip (not shown) to form a secure attachment between the cover 601 and the body 101.

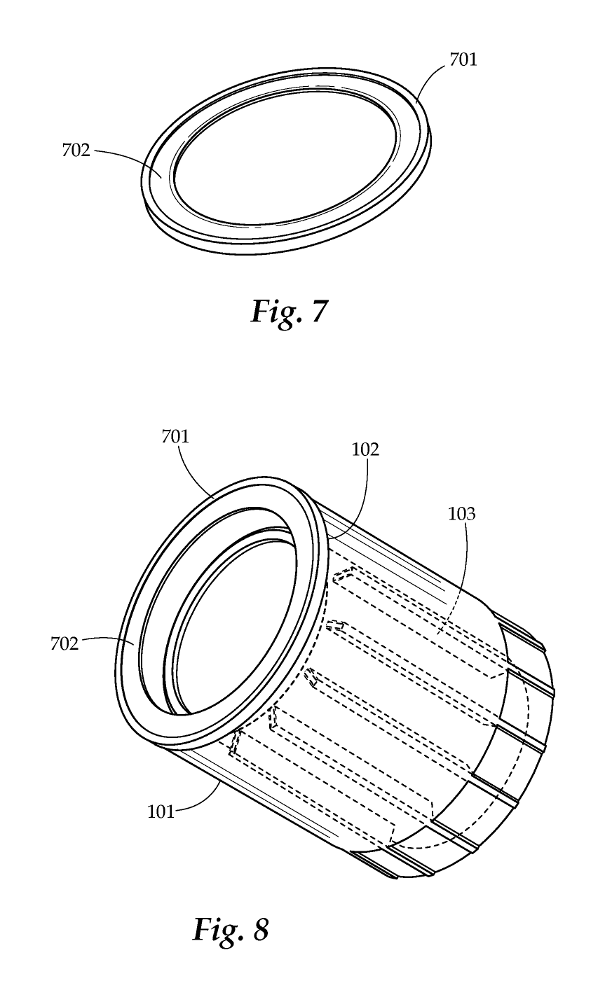

FIG. 7 provides a perspective view of an embodiment of an adapter for the drain cup. The adapter 701 is substantially circular in shape, and capable of attachment to the body (not shown). A flanged region 702 of the adapter 701 extends inwardly from an outer perimeter of the adapter 701.

FIG. 8 provides a perspective view of an embodiment of the drain cup having an adapter attached to its top. The drain cup has a body 101 which provides structure for the device. An upper lip 102 is formed by the body. The upper lip 102 may extend slightly from the remainder of the body 101. A plurality of ribs 103 are formed vertically on an inner surface of the body 101. The ribs 103 are configured to receive an oil filter (not shown). The adapter 701 is shown attached to the lip 102 at the top of the body 101. The adapter has a flanged region 702 which narrows the opening of the drain cup such that an oil filter may just fit through.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. An oil filter drain cup comprising:
a body, the body forming a container constructed and arranged to receive and contain the oil filter and a quantity of oil, the container having an opening at a top of the body through which an oil filter may pass;
wherein a portion of the container is sized to engage with at least a part of an outer surface of the oil filter, the portion configured to limit a movement of the oil filter in relation to the body when the oil filter is engaged with the portion.

2. The oil filter drain cup of claim 1 further comprising a cover attached to the body, the cover providing fluid communication to the container when in an open position, and obstructing fluid communication to the container when in a closed position.

3. The oil filter drain cup of claim 1 wherein the quantity of oil is received into the container from a gallery of a vehicle.

4. The oil filter drain cup of claim 1 wherein a top portion of the body is formed to be substantially flexible, and wherein a bottom portion of the body is formed to be substantially rigid.

5. The oil filter drain cup of claim 1 wherein the portion of the container sized to engage with at least a part of an outer surface of the oil filter is a rib protruding from an inner surface of the body into the container.

6. The oil filter drain cup of claim 5 wherein the rib is constructed and arranged to locate the oil filter when the oil filter is inserted into the container, to the rib being sized to provide a quantity of friction between a surface of the rib and an outer surface of the oil filter.

7. The oil filter drain cup of claim 5 further comprising a plurality of ribs.

8. The oil filter drain cup of claim 1 wherein the portion of the container sized to engage with at least a part of an outer surface of the oil filter is a slot formed by the body on a bottom portion of the container of the body, the slot being shaped to mate with a wrenching facet of the outer surface of the oil filter.

9. The oil filter drain cup of claim 1 wherein the body is substantially cylindrical.

10. The oil filter drain cup of claim 1 further comprising an adapter attached to a top of the body, the adapter having a flange which extends inwardly and forms an aperture just large enough to allow passage of the oil filter.

11. The oil filter drain cup of claim 1 wherein an outer surface of the body comprises a plurality of ridges.

12. The oil filter drain cup of claim 1 wherein the body forms an extending lip about a top portion, the extending lip increasing a diameter of the container at the top portion.

13. The oil filter drain cup of claim 2 wherein the cover is threadedly attached to the body when in a closed position.

14. A method of preventing oil spillage when removing an oil filter from a vehicle comprising the steps of:
loosening the oil filter partially;
placing an oil filter drain cup over the oil filter by inserting the oil filter into a container formed by a body of the drain cup, the inserting of the oil filter being against a friction force caused by an interference between the oil filter and an internal rib of the drain cup;
positioning the oil filter drain cup such that an outer wall of the drain cup extends past a top of the oil filter;
loosening the oil filter completely;
receiving the drained oil into the oil filter drain cup; and
securing a cover to the oil filter drain cup.

15. The method of preventing oil spillage when removing an oil filter from a vehicle of claim 14 further comprising the step of mating a slot feature of an interior face of the oil filter drain cup with a wrenching facet formed on an outer surface of the oil filter.

16. The method of preventing oil spillage when removing an oil filter from a vehicle of claim 14 wherein the step of rotatably unscrewing the oil filter completely comprises the step of rotating the oil filter drain cup until the oil filter is disengaged from the vehicle.

17. The method of preventing oil spillage when removing an oil filter from a vehicle of claim 14 further comprising the step of removing a new oil filter from the oil filter drain cup before the step of placing the oil filter drain cup over the oil filter by inserting the oil filter into a cavity formed by the drain cup.

18. The method of preventing oil spillage when removing an oil filter from a vehicle of claim 17 further comprising the step of receiving the oil filter drain cup and the new oil filter in a single package.

19. The method of preventing oil spillage when removing an oil filter from a vehicle of claim 14 further comprising the step of disposing of the drained oil and retaining the oil filter within the oil filter drain cup.

20. An oil filter drain cup comprising:
a body, the body forming a container constructed and arranged to receive and contain the oil filter and a quantity of oil remaining in a gallery of a vehicle, wherein the body is substantially cylindrical in shape;
a cover attached to the body, the cover providing fluid communication to the container when in an open position, and obstructing fluid communication to the container when in a closed position;
a plurality of vertically oriented ribs protruding from an inner surface of the body into the container, the plurality of ribs forming a portion of the container sized to frictionally engage with at least a part of an outer surface of the oil filter;
a slot formed by the body on a bottom portion of the container, the slot being shaped to mate with a wrenching facet of the outer surface of the oil filter, the slot limiting rotational motion of the oil filter in relation to the body when mated with the wrenching facets of the oil filter;
a plurality of ridges formed on an outer surface of the body; and
an extending lip formed by the body about a top portion, the extending lip increasing a diameter of the container at the top portion.
